(19) United States
(12) Patent Application Publication
(10) Pub. No.: US 2026/0133773 A1
(43) Pub. Date: May 14, 2026

(54) EXTENDABLE BUILD SYSTEM FOR MULTIPLE RUNTIME ENVIRONMENTS

(71) Applicant: Red Hat, Inc., Raleigh, NC (US)

(72) Inventors: Leonardo Rossetti, Sao Paolo (BR); Leigh Griffin, Waterford (IE)

(21) Appl. No.: 18/944,593

(22) Filed: Nov. 12, 2024

(51) Int. Cl. G06F 8/41

(52) U.S. Cl. CPC G06F 8/41

(57) ABSTRACT

Techniques described herein relate to an extendable build system for generating software artifacts in multiple runtime environments. For example, a build system can receive a request from a client system to generate a software artifact in a particular runtime environment. The build system can include an interface that can enforce characteristics of the software artifact. The interface can be coupled to plugins that are each associated with a unique runtime environment. The build system can select a plugin associated with the particular runtime environment. The selected plugin can cause the software artifact that has the characteristics enforced by the interface to be generated in the particular runtime environment. The build system can receive access to the generated software artifact from the plugin and can provide the access to the client system in response to the request.

### TECHNICAL FIELD

The present disclosure relates generally to software build systems. More specifically, but not by way of limitation, this disclosure relates to extendable build systems for multiple runtime environments.

### BACKGROUND

Build systems are complex pieces of software that can automate processes to generate builds of software artifacts. For instance, build systems may run a sequence of operations to generate (and in some cases, configure, test, or deploy) a software artifact in a runtime environment, with minimal or no user interaction. A build system may generate a software artifact by compiling source code in a particular order into executable programs, libraries, and other software components. The resulting software artifact can be run on a computing system.

### BRIEF DESCRIPTION OF THE DRAWINGS

FIG. 1 is a block diagram of an example of a computing environment with an extendable build system supporting multiple runtime environments, according to some aspects of the present disclosure.

FIG. 2 is a block diagram of another example of a computing environment with an extendable build system supporting multiple runtime environments, according to some aspects of the present disclosure.

FIG. 3 is a flowchart of an example of a process for using an extendable build system to support multiple runtime environments, according to some aspects of the present disclosure.

### DETAILED DESCRIPTION

A build system can generate a software build in a runtime environment, such as a cloud computing environment, a data center, an edge device, a local development machine, a bare metal server, and so forth. Different runtime environments may have significantly different software and hardware characteristics. As such, conventionally, the build system may be specialized to generate software builds for a particular runtime environment. Using such a build system to generate software builds in other runtime environments may result in software builds with substandard performance compared to software builds generated in the particular runtime environment to which the build system is specialized. Further, it may be computationally expensive and time consuming to use such a build system to generate multiple software artifacts in parallel in different runtime environments. This is because generating multiple software artifacts in parallel may involve the build system translating between multiple types of machine code for the different runtime environments.

Some examples of the present disclosure can overcome one or more of the issues mentioned above by using an extendable build system that includes an interface that can enforce characteristics of a software artifact but does not generate the software artifact itself. Instead of having the build system generate the software artifact, plugins for the interface can cause generation of the software artifact in the runtime environment. Each plugin can be specialized for a unique runtime environment. The interface can define the features of the software artifact, while the plugins can implement the actual build process of the software artifact – which may differ based on the associated runtime environment. Using specialized plugins for different runtime environments can allow the build system to generate software artifacts in multiple runtime environments faster and with reduced resource consumption compared to conventional build systems. Further, the extendable build system described herein can provide flexibility for additional runtime environments. For example, as new devices or architectures continue to be developed, associated plugins for such devices or architectures can also be developed and integrated into the build system. Additionally, the build system described herein may also use the plugins to generate multiple software artifacts in parallel in different runtime environments.

In a particular example, a build system can include an interface that specifies characteristics (e.g., features and other requirements) of a software artifact, such as a container, a software package, an image file, or any other suitable software artifact. The interface may not actually generate software builds. Instead, plugins may connect to the interface. Each plugin can be specialized to produce the software build in a unique runtime environment such that the software build has the characteristics required by the interface. As the different runtime environments may have differing hardware characteristics and software characteristics, different plugins may have different build processes to result in the same software artifact having the required characteristics.

In some examples, more than one plugin can be used at the same time. For example, during development, a software artifact may be built locally (e.g., in a first runtime environment) via a first plugin. After development, two versions of the software artifact can be developed in parallel at the same time to test the software artifact. For example, a second plugin connected to the interface can cause the software artifact to be built in another runtime environment, such as in a remote computing cluster. In parallel, the first plugin can cause the software artifact to be built locally. The software artifacts developed in the different runtime environments can be compared to ensure that the software artifact built in the remote computing cluster has the same characteristics required by the interface.

In some examples, the build of the software artifact may fail in a runtime environment. In such examples, the plugin for that runtime environment can alert the build system to the failure. The plugin may also return an error report for the build failure to the build system. Instead of returning the software artifact, or a link to the software artifact, to the client system, the build system can return the error log to the client system.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

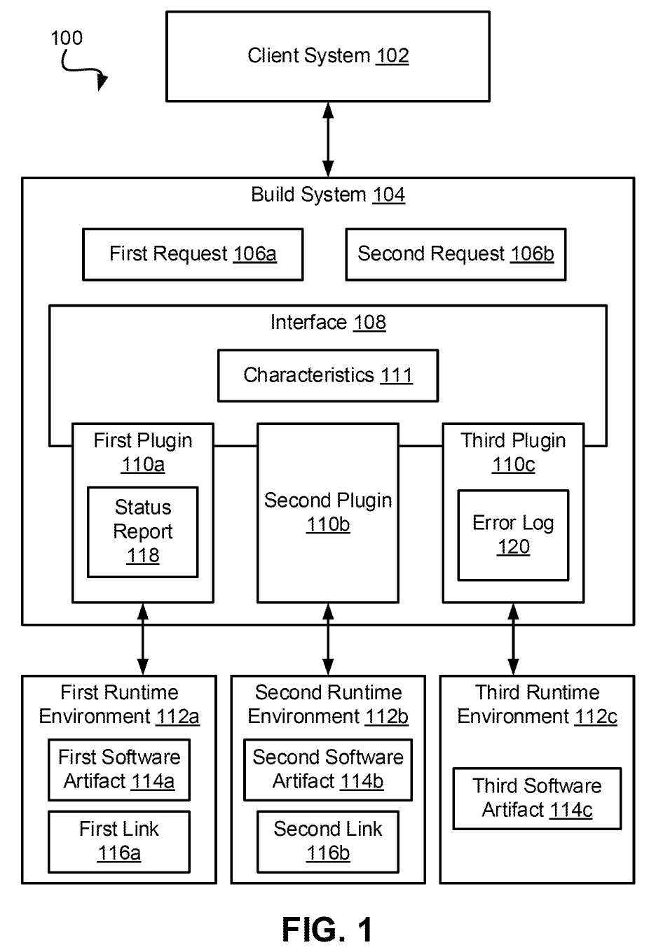

FIG. 1 is a block diagram of an example of a computing environment 100 with an extendable build system 104 supporting multiple runtime environments 112a-c, according to some aspects of the present disclosure. The computing environment 100 can include a client system 102 and multiple runtime environments 112a-c communicatively coupled to the build system 104.

In some examples, the computing environment 100 and/or the build system 104 may be a distributed computing environment that includes multiple devices in communication via a network, such as a local area network or the Internet. Alternatively, the computing environment 100 and/or the build system 104 may be a single device, such as a laptop, desktop, or any other suitable computing device. The client system 102 may be a distributed computing system or a single device.

The build system 104 can have a plugin architecture that can allow software artifacts to be built in multiple runtime environments 112a-c. The runtime environments 112a-c may each be unique runtime environments, such as bare metal servers, edge devices, automotive devices, computing clusters, cloud computing environments, containers, virtual machines, or any other type of runtime environment. Rather than creating the build system 104 to generate software artifacts that are specialized to a particular runtime environment, the build system 104 can include an interface 108 that can couple to plugins 110a-c that are each specialized for different runtime environments. For example, a first plugin 110a can be specialized to generate a software artifact in the first runtime environment 112a, which may be a local device on which the build system 104 is executed (e.g., locally used container tools such as Podman). A second plugin 110b can be specialized to generate a software artifact in the second runtime environment 112b, which may be a cloud provider. A third plugin 110c can be specialized to generate a software artifact in the third runtime environment 112c, which may be a containerization software platform such as Red Hat OpenShift.

The plugins 110a-c can cause the same software artifact to be generated in the different runtime environments 112a-c, but according to different processes based on the inherent differences (e.g., differences in software or hardware) in runtime environments 112a-c. For example, the interface 108 to which the plugins 110a-c are coupled can enforce characteristics 111 of software artifacts 114a-c generated in the runtime environments 112a-c. Characteristics 111 can include features or other requirements that the generated software artifacts 114a-c can include or perform. The interface 108 or the build system 104 (e.g., components of the build system 104 not including the plugins 110a-c) may not themselves perform a build of generated software artifacts 114a-c. Instead, the plugins 110a-c may be responsible for causing the generated software artifacts 114a-c to be built in the runtime environments 112a-c. The interface 108 may define “what” a software artifact does (e.g., via the characteristics 111) and the plugins 110a-c may each have unique processes for “how” the software artifact is generated. In other words, the build system 104 may be environment agnostic.

For example, a client system 102 may transmit a first request 106a to the build system 104. The first request 106a may request that one or more software artifacts be generated in one or more particular runtime environments. In particular, the first request 106a may specify that a software artifact be generated in both the first runtime environment 112a and the second runtime environment 112b. The build system 104 can, based on the first request 106a, select the plugin associated with the first runtime environment 112a, such as the first plugin 110a, and the plugin associated with the second runtime environment 112b, such as the second plugin 110b. The selection of the first plugin 110a and second plugin 110b can cause the first plugin 110a and second plugin 110b to enable generation of software artifacts.

For example, the first plugin 110a may compile source code for the software artifact on the local device hosting the build system 104 and perform any other operations involved in generating a build of the first software artifact 114a. The first plugin 110a can return the first software artifact 114a to the build system 104, which can in turn return the first software artifact 114a to the client system 102 in response to the first request 106a. Additionally or alternatively, the first plugin 110a can transmit a first link 116a (e.g., a uniform resource locator (URL)) to the build system 104, which can return the first link 116a to the client system 102 in response to the first request 106a. The client system 102 can use the first link 116a to access the first software artifact 114a.

In parallel (e.g., at the same time) with generation of the first software artifact 114a in the first runtime environment 112a, the second plugin 110b can cause a second software artifact 114b to be generated in the second runtime environment 112b. The second software artifact 114b can have the same characteristics 111 as the first software artifact 114a, but may be executed more efficiently (e.g., with reduced latency and consumption of computing resources) in computing environments that are the same as or similar to the second runtime environment 112b, compared to executing the second software artifact 114b in other computing environments (e.g., similar to the first runtime environment 112a or the third runtime environment 112c).

To cause the second software artifact 114b to be generated in the second runtime environment 112b (e.g., a cloud provider), the second plugin 110b can send a command to the second runtime environment 112b to create a container. The second plugin 110b can prompt the second runtime environment 112b to pull source code into the container and perform any other necessary steps to generate a build of the second software artifact 114b inside the container. When the second software artifact 114b is built, the second runtime environment 112b can be prompted by the second plugin 110b to archive the second software artifact 114b as a shared volume accessible via a second link 116b (e.g., a URL). The second link 116b can be used to access the second software artifact 114b from the container in the second runtime environment 112b. The second runtime environment 112b can return the second link 116b to the second plugin 110b, which can provide the second plugin 110b to the build system 104. The build system 104 can then transmit the second link 116b to the client system 102 in response to the first request 106a.

In some examples, the plugins 110a-c can send status reports 118 to the build system 104 while builds of the software artifacts 114a-c are being generated in the runtime environments 112a-c. For example, each build step in the build process of generating the first software artifact 114a in the first runtime environment 112a (e.g., as performed by the first runtime environment 112a) can be reported by the first plugin 110a to the build system 104. This can allow the build system 104 to be aware of the current state or phase of the build in the first runtime environment 112a.

In some examples, building a software artifact in a runtime environment may fail. For example, the client system 102 can transmit a second request 106b to the build system 104 for a software artifact generated in the third runtime environment 112c, which may be a remote device running OpenShift. The third plugin 110c can prompt the third runtime environment 112c to generate the third software artifact 114c. But, at some point in the build process, generation of the third software artifact 114c may fail. Since the build system 104 cannot return the third software artifact 114c (or access to the third software artifact 114c) to the client system 102 in response to the second request 106b, the build system 104 can instead return an error log 120. The error log 120 may be generated by the third runtime environment 112c and/or the third plugin 110c. In some examples, the error log 120 may include a status report 118 of the steps that were performed in the attempt to generate the third software artifact 114c.

While FIG. 1 depicts a specific arrangement of components, other examples can include more components, fewer components, different components, or a different arrangement of components than is shown in FIG. 1. For example, the computing environment 100 can include more or fewer plugins 110a-c, more or fewer software artifacts 114a-c or types of software artifacts, more or fewer unique runtime environments 112a-c, etc. Additionally, any component or combination of components depicted in FIG. 1 can be used to implement the process(es) described herein.

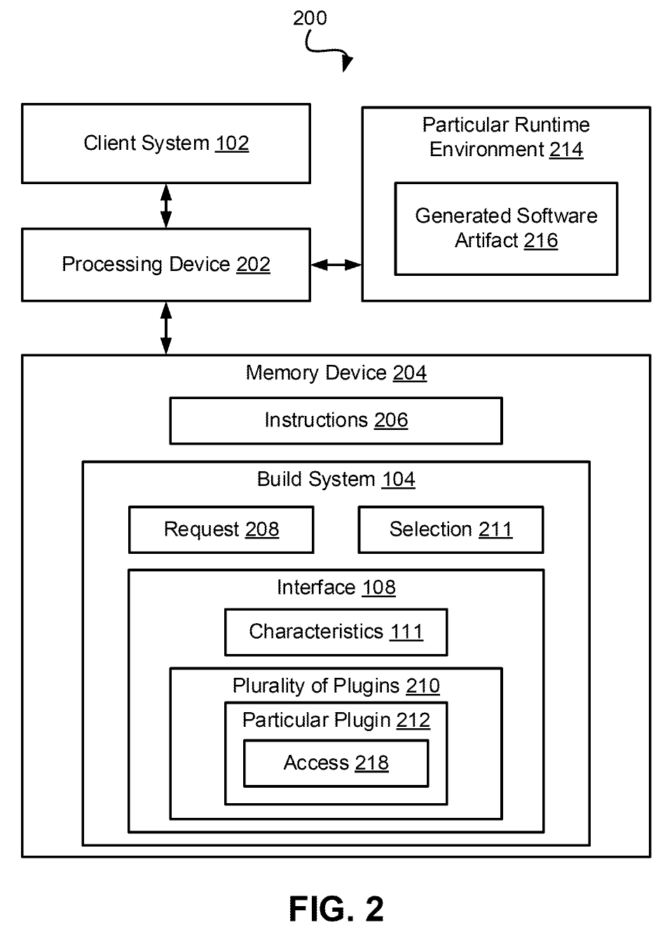

FIG. 2 is a block diagram of another example of a computing environment 200 with an extendable build system 104 supporting multiple runtime environments, according to some aspects of the present disclosure. The computing environment 200 depicted in FIG. 2 includes a processing device 202 communicatively coupled with a memory device 204. In some examples, the components of the computing environment 200, such as the processing device 202 and the memory device 204, may be part of a same computing device. In other examples, the processing device 202 and the memory device 204 can be included in separate computing devices that are communicatively coupled.

The processing device 202 can include one processing device or multiple processing devices. Non-limiting examples of the processing device 202 include a Field-Programmable Gate Array (FPGA), an application-specific integrated circuit (ASIC), a microprocessor, etc. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, etc.

The memory device 204 can include one memory or multiple memories. The memory device 204 can be non-volatile and may include any type of memory that retains stored information when powered off. Non-limiting examples of the memory device 204 include electrically erasable and programmable read-only memory (EEPROM), flash memory, or any other type of non-volatile memory. At least some of the memory can include a non-transitory computer-readable medium from which the processing device 202 can read instructions 206. The non-transitory computer-readable medium can include electronic, optical, magnetic, or other storage devices capable of providing the processing device with computer-readable instructions or other program code. Examples of the non-transitory computer-readable medium include magnetic disk(s), memory chip(s), ROM, RAM, an ASIC, a configured processor, optical storage, or any other medium from which a computer processor can read the instructions 206.

In some examples, the processing device 202 can execute the instructions 206 to perform some or all of the functionality described herein. For example, the processing device 202 can receive, by a build system 104 and from a client system 102, a request 208 to generate a software artifact in a particular runtime environment 214. The build system 104 can comprise an interface 108 that is configured to enforce characteristics 111 of the software artifact. The interface 108 can be coupled to a plurality of plugins 210. Each plugin of the plurality of plugins 210 can be associated with a unique runtime environment. The processing device 202 can select (e.g., generate a selection 211), by the build system 104 and in response to the request 208, a particular plugin 212 of the plurality of plugins 210 that is associated with the particular runtime environment 214 in the request 208. The particular plugin 212 can be configured to, in response to the selection 211, cause the software artifact having the characteristics 111 enforced by the interface 108 to be generated in the particular runtime environment 214. The processing device 202 can receive, by the build system 104 and from the particular plugin 212, access 218 to a generated software artifact 216 built in the particular runtime environment 214 by the particular plugin 212. The processing device 202 can provide, by the build system 104 and to the client system 102, the access 218 to the generated software artifact 216 in response to the request 208.

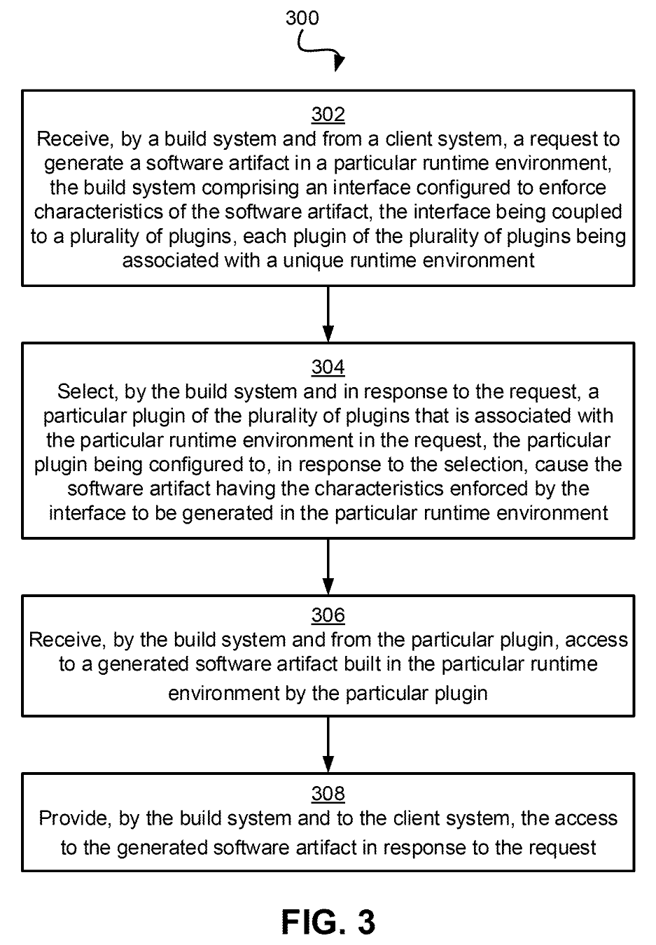

FIG. 3 is a flowchart of an example of a process 300 for using an extendable build system 104 to support multiple runtime environments 112a-c, according to some aspects of the present disclosure. In some examples, the processing device 202 can implement some or all of the steps shown in FIG. 3. Additionally, in some examples, the processing device 202 can be executing the build system 104, the interface 108, the plugins 110a-c, or any suitable component of FIGS. 1-2 to implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processing device 202 can receive, by a build system 104 and from a client system 102, a request 208 to generate a software artifact in a particular runtime environment 214. The build system 104 can include an interface 108 that can enforce characteristics 111 of the software artifact. The interface 108 can be coupled to a plurality of plugins 210. Each plugin of the plurality of plugins 210 can be associated with a unique runtime environment. For example, each plugin of the plurality of plugins 210 can be associated with different runtime environments such as a bare metal server, an edge device, a computing cluster, a cloud computing environment, a container, a virtual machine, or any suitable computing environment in which software artifacts can be built.

At block 304, the processing device 202 can select, by the build system 104 and in response to the request 208, a particular plugin 212 of the plurality of plugins 210 that is associated with the particular runtime environment 214 in the request 208. The particular plugin 212 can, in response to the selection 211, cause the software artifact having the characteristics 111 enforced by the interface 108 to be generated in the particular runtime environment 214. Each plugin of the plurality of plugins 210, no matter their associated runtime environment, can be configured to cause a build of the same generated software artifact 216 (e.g., having the same characteristics 111 enforced by the interface 108). But the build processes for the different plugins in the plurality of plugins 210 may differ according to the differing hardware and software requirements of the different runtime environments. The build system 104 and the interface 108 may be unaware of the build processes enacted by the plurality of plugins 210.

At block 306, the processing device 202 can receive, by the build system 104 and from the particular plugin 212, access 218 to a generated software artifact 216 built in the particular runtime environment 214 by the particular plugin 212. For example, the particular runtime environment 214 may create a shared volume with a link (e.g., a URL) that can be used to access the generated software artifact 216. The particular plugin 212 can transmit the link to the build system 104. Additionally or alternatively, the particular plugin 212 can transmit the generated software artifact 216 itself to the build system 104.

At block 308, the processing device 202 can provide, by the build system 104 and to the client system 102, the access 218 to the generated software artifact 216 in response to the request 208. For example, the build system 104 can transmit the generated software artifact 216 to the client system 102. Or, the build system 104 can transmit a link to the generated software artifact 216 to the client system 102. In some examples, the particular runtime environment 214 may fail to build the generated software artifact 216. In such examples, the particular plugin 212 can transmit an error log 120 generated by the particular runtime environment 214 or the particular plugin 212 to the build system 104. The build system 104 can then transmit the error log 120 to the client system 102 in response to the request 208 in lieu of the generated software artifact 216.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a non-transitory memory device comprising instructions that are executable by the processing device for causing the processing device to:
receive, by a build system and from a client system, a request to generate a software artifact in a particular runtime environment, the build system comprising an interface configured to enforce characteristics of the software artifact, the interface being coupled to a plurality of plugins, each plugin of the plurality of plugins being associated with a unique runtime environment;
select, by the build system and in response to the request, a particular plugin of the plurality of plugins that is associated with the particular runtime environment in the request, the particular plugin being configured to, in response to the selection, cause the software artifact having the characteristics enforced by the interface to be generated in the particular runtime environment;
receive, by the build system and from the particular plugin, access to a generated software artifact built in the particular runtime environment by the particular plugin; and
provide, by the build system and to the client system, the access to the generated software artifact in response to the request.

2. The system of claim 1, wherein the particular plugin is a first plugin, the particular runtime environment is a first runtime environment, and the generated software artifact is a first software artifact, wherein the request further comprises generating the software artifact in the first runtime environment and a second runtime environment, and wherein the non-transitory memory device further comprises instructions that are executable by the processing device for causing the processing device:
select, by the build system, a second plugin of the plurality of plugins that is associated with the second runtime environment, wherein the second runtime environment differs from the first runtime environment,
wherein the second plugin is configured to cause a second software artifact to be generated in the second runtime environment in parallel with the first plugin causing the first software artifact to be generated in the first runtime environment.

3. The system of claim 2, wherein the first software artifact and the second software artifact each comprise the characteristics enforced by the interface, and wherein the first software artifact is generated in the first runtime environment via a first process that differs from a second process used to generate the second software artifact in the second runtime environment.

4. The system of claim 1, wherein the request is a first request and the generated software artifact is a first software artifact, and wherein the non-transitory memory device further comprises instructions that are executable by the processing device for causing the processing device to:
receive, by the build system and from the client system, a second request to generate a third software artifact in the particular runtime environment; and
select, by the build system and in response to the second request, the particular plugin associated with the particular runtime environment, the particular plugin being configured to cause the third software artifact having the characteristics enforced by the interface to be generated in the particular runtime environment,
wherein the particular plugin is configured to determine that the third software artifact failed to generate in the particular runtime environment.

5. The system of claim 4, wherein the non-transitory memory device further comprises instructions that are executable by the processing device for causing the processing device to:
receive, by the build system and from the particular plugin, an error log for the third software artifact in response to the particular plugin determining that the third software artifact failed to generate in the particular runtime environment; and
transmit, by the build system and to the client system, the error log in response to the request.

6. The system of claim 1, wherein the non-transitory memory device further comprises instructions that are executable by the processing device for causing the processing device to:
receive, by the build system and from the particular plugin, a status report for a build step for generating the software artifact in the particular runtime environment.

7. The system of claim 1, wherein the plurality of plugins is associated with a plurality of runtime environments comprising at least two of a bare metal server, an edge device, a computing cluster, and a cloud computing environment.

8. A method comprising:
receiving, by a processing device executing a build system and from a client system, a request to generate a software artifact in a particular runtime environment, the build system comprising an interface configured to enforce characteristics of the software artifact, the interface being coupled to a plurality of plugins, each plugin of the plurality of plugins being associated with a unique runtime environment;
selecting, by the processing device executing the build system and in response to the request, a particular plugin of the plurality of plugins that is associated with the particular runtime environment in the request, the particular plugin being configured to, in response to the selection, cause the software artifact having the characteristics enforced by the interface to be generated in the particular runtime environment;
receiving, by the processing device executing the build system and from the particular plugin, access to a generated software artifact built in the particular runtime environment by the particular plugin; and
providing, by the processing device executing the build system and to the client system, the access to the generated software artifact in response to the request.

9. The method of claim 8, wherein the particular plugin is a first plugin, the particular runtime environment is a first runtime environment, and the generated software artifact is a first software artifact, wherein the request further comprises generating the software artifact in the first runtime environment and a second runtime environment, and wherein the method further comprises:
selecting, by the build system, a second plugin of the plurality of plugins that is associated with the second runtime environment, wherein the second runtime environment differs from the first runtime environment,
wherein the second plugin is configured to cause a second software artifact to be generated in the second runtime environment in parallel with the first plugin causing the first software artifact to be generated in the first runtime environment.

10. The method of claim 9, wherein the first software artifact and the second software artifact each comprise the characteristics enforced by the interface, and wherein the first software artifact is generated in the first runtime environment via a first process that differs from a second process used to generate the second software artifact in the second runtime environment.

11. The method of claim 8, wherein the request is a first request and the generated software artifact is a first software artifact, and wherein the method further comprises:
receiving, by the build system and from the client system, a second request to generate a third software artifact in the particular runtime environment; and
selecting, by the build system and in response to the second request, the particular plugin associated with the particular runtime environment, the particular plugin being configured to cause the third software artifact having the characteristics enforced by the interface to be generated in the particular runtime environment,
wherein the particular plugin is configured to determine that the third software artifact failed to generate in the particular runtime environment.

12. The method of claim 11, further comprising:
receiving, by the build system and from the particular plugin, an error log for the third software artifact in response to the particular plugin determining that the third software artifact failed to generate in the particular runtime environment; and
transmitting, by the build system and to the client system, the error log in response to the request.

13. The method of claim 8, further comprising:
receiving, by the build system and from the particular plugin, a status report for a build step for generating the software artifact in the particular runtime environment.

14. The method of claim 8, wherein the plurality of plugins is associated with a plurality of runtime environments comprising at least two of a bare metal server, an edge device, a computing cluster, and a cloud computing environment.

15. A non-transitory computer-readable medium comprising program code that is executable by a processing device for causing the processing device to:
receive, by a build system and from a client system, a request to generate a software artifact in a particular runtime environment, the build system comprising an interface configured to enforce characteristics of the software artifact, the interface being coupled to a plurality of plugins, each plugin of the plurality of plugins being associated with a unique runtime environment;
select, by the build system and in response to the request, a particular plugin of the plurality of plugins that is associated with the particular runtime environment in the request, the particular plugin being configured to, in response to the selection, cause the software artifact having the characteristics enforced by the interface to be generated in the particular runtime environment;
receive, by the build system and from the particular plugin, access to a generated software artifact built in the particular runtime environment by the particular plugin; and
provide, by the build system and to the client system, the access to the generated software artifact in response to the request.

16. The non-transitory computer-readable medium of claim 15, wherein the particular plugin is a first plugin, the particular runtime environment is a first runtime environment, and the generated software artifact is a first software artifact, wherein the request further comprises generating the software artifact in the first runtime environment and a second runtime environment, and wherein the program code is further executable by the processing device for causing the processing device:
select, by the build system, a second plugin of the plurality of plugins that is associated with the second runtime environment, wherein the second runtime environment differs from the first runtime environment,
wherein the second plugin is configured to cause a second software artifact to be generated in the second runtime environment in parallel with the first plugin causing the first software artifact to be generated in the first runtime environment.

17. The non-transitory computer-readable medium of claim 16, wherein the first software artifact and the second software artifact each comprise the characteristics enforced by the interface, and wherein the first software artifact is generated in the first runtime environment via a first process that differs from a second process used to generate the second software artifact in the second runtime environment.

18. The non-transitory computer-readable medium of claim 15, wherein the request is a first request and the generated software artifact is a first software artifact, and wherein the program code is further executable by the processing device for causing the processing device to:
receive, by the build system and from the client system, a second request to generate a third software artifact in the particular runtime environment; and
select, by the build system and in response to the second request, the particular plugin associated with the particular runtime environment, the particular plugin being configured to cause the third software artifact having the characteristics enforced by the interface to be generated in the particular runtime environment,
wherein the particular plugin is configured to determine that the third software artifact failed to generate in the particular runtime environment.

19. The non-transitory computer-readable medium of claim 18, wherein the program code is further executable by the processing device for causing the processing device to:
receive, by the build system and from the particular plugin, an error log for the third software artifact in response to the particular plugin determining that the third software artifact failed to generate in the particular runtime environment; and
transmit, by the build system and to the client system, the error log in response to the request.

20. The non-transitory computer-readable medium of claim 15, wherein the program code is further executable by the processing device for causing the processing device to:
receive, by the build system and from the particular plugin, a status report for a build step for generating the software artifact in the particular runtime environment.
